(19) United States
(12) Patent Application Publication
(10) Pub. No.: US 2011/0219294 A1
(43) Pub. Date: Sep. 8, 2011

(54) System And Method For Automatic Continuation Marks In An Electronic Publication

(75) Inventors: William LESHNER, San Diego, CA (US); Brady DUGA, Carlsbad, CA (US); Garth CONBOY, La Jolla, CA (US); John RIVLIN, Palo Alto, CA (US); Vincent LE CHEVALIER, San Jose, CA (US); Ruze RICHARDS, Holmdel, NJ (US)

(73) Assignee: SKIFF, INC., New York, NY (US)

(21) Appl. No.: 12/717,412

(22) Filed: Mar. 4, 2010

(51) Int. Cl. G06F 17/00

(52) U.S. Cl. 715/234; 715/243

(57) ABSTRACT

A system and method for automatic continuation marks in an electronic publication is disclosed. The method may include using a computer processor, identifying a first part of electronic content that can be rendered in an text box on a display of an electronic device; using the computer processor, calculating a position for a continuation marker to be displayed in the electronic content; using the computer processor, linking the continuation mark to a second part of the electronic content; and using the computer processor, automatically inserting the continuation mark in the electronic content following the first part of the electronic content. An electronic device that renders a electronic content is disclosed. may include a processor; a user interface; a display; and a memory comprising code that when executed by the processor performs the following: identify a first part of electronic content that can be rendered in a text box rendered on an electronic device; render a first part of the electronic content in the text box; render a continuation mark in the text box at the end of the first part of the electronic content; and hide a second part of the electronic content.

### BACKGROUND INFORMATION

Electronic publications may provide content in text boxes or windows. Using the Cascading Style Sheets, or “CSS,” a content author, publisher, or user may specify what happens to the content should amount of content exceed the space provided within the text box. For example, the “overflow: hidden” CSS style can be used to specify that the content should be truncated when it reaches the bottom of a specified box.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a block diagram of an electronic device according to one embodiment;

FIG. 2 is a block diagram of a system for automatic continuation marks in an electronic publication according to one embodiment;

FIG. 3 is a flowchart depicting a method for automatic continuation marks in an electronic publication according to one embodiment;

FIG. 4 is an example of content markup according to one embodiment;

FIG. 5 is an example of a text box displaying content according to one embodiment;

FIG. 6 is another example of a text box displaying content according to one embodiment.

FIG. 7 is an example of a text box displaying content according to another embodiment;

FIG. 8 is a flowchart depicting a method for rendering electronic content with continuation marks in an electronic publication according to one embodiment;

FIG. 9 is a flowchart depicting a method of modifying the location of a continuation mark according to one embodiment; and

FIG. 10 is a flowchart depicting a method of rendering content with continuation marks using an electronic device according to one embodiment.

### DETAILED DESCRIPTION OF PREFERRED EMBODIMENTS

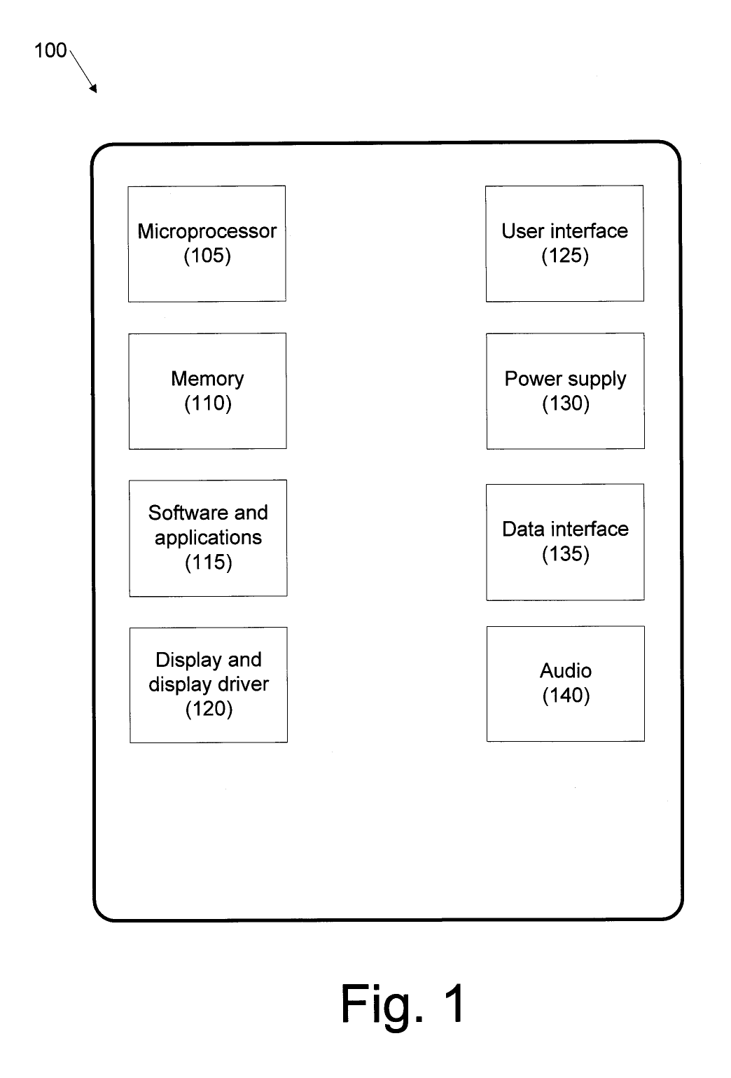

Several embodiments of the present invention and their advantages may be understood by referring to FIGS. 1-10, wherein like reference numerals refer to like elements.

Cascading Style Sheets, or “CSS,” is a style sheet language that allows authors and users to attach styles, such as fonts and spacing, to structured documents. CSS allows the separation of the presentation style of documents from the content of documents. The Cascading Style Sheets Level 2 Revision 1 (CSS 2.1) Specification is hereby incorporated by reference in its entirety.

When the “overflow: hidden” CSS property is used, the content that overflows the text box is hidden and not displayed to the user. Because the content within a text box may have multiple zoom states (i.e., stepped increases of font size from markup-specified base size of preceding content on the page), and the text box itself may have multiple sizes, the amount of content that is displayed (and the amount of content that is hidden) may vary. Given these variances, it is not possible to determine where the first, or lead, part of an article will be truncated due to its “overflow: hidden” styling. Thus, CSS/XHTML cannot be used to reliably insert into the markup stream an indication that additional content is available.

The present invention, according to one embodiment, provides electronic publication authors, content creators, designers and/or editors with the ability to include an indicator, or continuation mark, that informs the user that additional content is available should content be hidden by the “overflow: hidden” style. In one embodiment, content may be truncated on word boundaries and a continuation mark, or link, may be automatically inserted at the point of truncation. Depending upon the zoom state of the content, the text box size, etc., the continuation mark may be inserted at different places in the content flow so that it is positioned at a language-appropriate location. For example, for left-to-right/horizontal text (e.g., English), the continuation mark may be positioned in the bottom-right corner of the text box, but for right-to-left/vertical text (e.g., Japanese), the mark might go in the bottom-left corner. Other positions and locations may be used as necessary and/or desired.

In one embodiment, the overflow content, the positioning of the continuation mark, and links to the overflow content may be determined by the software at the point of compilation. In another embodiment, these determinations may be made by the rendering software executing on an electronic device. In another embodiment, these determinations may be made by a combination of the compiling software and the rendering device. These determinations may be performed by other hardware and/or software as necessary and/or desired.

By selecting the continuation mark, some or all of the overflow, or hidden, content will be displayed for the user. Thus, it is possible to think of the continuation mark may as a hyperlink to content.

In one embodiment, if the overflow content does not fill the entire text box, some of the first part of the text may be rendered along with the hidden text to fill out the text box. In one embodiment, a leading indicator, such as ellipses (“ . . . ”) may be provided to introduce the overflow content.

The continuation mark links may include text, graphics, markup, or any other suitable indicator.

According to one embodiment, a new CSS feature, called “display: continuation-mark”, may be used in the style sheet to implement the continuation mark. An example style, including the “overflow:hidden” feature and the “display: continuation-mark” feature is as follows:

```
    <style>
      .article_style {
      position: absolute;
      overflow: hidden;
      top: 62mm; left: 4mm; width: 60mm; height: 50mm;
      padding: 1mm;
      }
      .continuation {
      display: continuation-mark;
      font-family: serif;
      font-weight: bold;
      }
</style>
```

In this example, the continuation mark will be displayed in the serif font and in bold.

The continuation mark that is to be used may be a child element of the parent in which the continuation mark is to appear. For example, the markup for content may define the continuation mark to be “more . . . ” as follows:

<div class=”continuation”>
<a href=”#fullarticle”>more...</a>
</div>

Referring to FIG. 1, a block diagram of an electronic device is provided. In general, electronic device 100 may include processor 105, memory 110, software and applications 115, display and display driver 120, user interface 125, power supply 130, data interface 135, and audio 140. Other features may be provided as necessary and/or desired.

Processor 105 provides some, or all, of the processing power for electronic device 100. Processor 105 may be any suitable processor or integrated circuit, including microprocessors, programmed microprocessors micro-controllers, peripheral integrated circuit elements, CSICs (Customer Specific Integrated Circuit) or ASICs (Application Specific Integrated Circuit), logic circuits, digital signal processors, programmable logic devices such as FPGAs, PLDs, PLAs or PALs, or any other device or arrangement of devices that is capable of performing the function of a microprocessor.

Memory 110 may be any suitable memory, and may be used to store software and applications 115. Memory 110 may be volatile or non-volatile as necessary and/or desired. Memory 110 may include static RAM, dynamic RAM, flash memory, magnetic memory, optical memory, etc.

In one embodiment, memory 110 may store data files, including electronic content files, style sheets, advertisements, user preferences, etc. In one embodiment, software and applications 115 may render an image on the display of electronic device 100.

Display and drivers 120 are provided for displaying characters, graphics, videos, pictures, etc. for the user. The display may be a suitable low-power display, including flexible displays, touch-sensitive displays, etc.

User interface 125 may be provided for the user to interact with electronic device 100. Any suitable input mechanism may be provided, including buttons, trackballs, joysticks, a stylus, etc. In another embodiment, a touch-sensitive screen may be provided. In still another embodiment, a microphone may be provided to detect speech. In another embodiment, a digital camera may be provided. Other inputs may be provided as necessary and/or desired, depending on particular functionality that the electronic device provides.

Electronic device 100 may be powered by power supply 130, such as a battery, AC power, DC power through an AC adapter, etc.

Electronic device 100 may also be provided with data interface 135. In one embodiment, data interface may communicate by any suitable wired or wireless communication method, including cellular communications, a USB interface, unshielded twisted pair interface, radio frequency (RF), infrared (IR), Bluetooth, near field communication, WiFi (e.g., any suitable IEEE 802.11 protocol), etc.

In one embodiment, electronic device 100 may be provided with audio capability 140. This may include integrated speakers, a headphone jack, etc.

In one embodiment, electronic device 100 may be provided with a location sensing device, such as a GPS device (not shown).

Any electronic device having a display that can render electronic content or images may be used. In one embodiment, electronic device 100 may be an electronic reading device. Examples of electronic reading devices include electronic book readers, electronic newspaper readers, electronic paper readers, etc. Examples of an electronic display device are disclosed in U.S. patent application Ser. No. 12/481,677, entitled “Flexible Electronic Device And Method Of Manufacture”; U.S. patent application Ser. No. 12/248,331, entitled “Foldable Media Device,” U.S. patent application Ser. No. 12/332,860, entitled “Touch Sensitive Illuminated Display”; U.S. patent application Ser. No. 12/549,785, entitled “Thin Reader Device”; and U.S. patent application Ser. No. 12/574,721 entitled “Always On Reader Device.” The disclosures of each of these patent applications is incorporated, by reference, in its entirety.

Other examples of electronic reading devices include the Amazon Kindle, the Sony Reader, the Plastic Logic Reader, and the iRex iLiad electronic reader.

Other examples of electronic devices include computers (desktops, notebooks, laptops, tablets, webbooks, netbooks, etc.), personal digital assistants (PDAs), digital cameras, digital picture frames, music players, portable video players, video game players, telephones, mobile telephones, etc.

Other related disclosures include U.S. Patent Appl'n Ser. No. 60/978,748, entitled “Content Distribution And Preloading”; U.S. patent application Ser. No. 12/481,336, entitled “System And Method For Providing Spatial And Temporal Content In An Electronic Device”; U.S. patent application Ser. No. 12/481,705, entitled “System And Method For Providing Sub-Publication Content In An Electronic Device”; U.S. patent application Ser. No. 12/481,306, entitled “Electronic Paper Display Device Event Tracking”; U.S. patent application Ser. No. 12/481,365, entitled “System And Method For Delivering Publication Content To Reader Devices Using Mixed Mode Transmission”; U.S. patent application Ser. No. 12/575,009 entitled “Electronic Advertisement Placement”; U.S. patent application Ser. No. 12/481,365 entitled “System And Method For Delivering Publication Content To Reader Devices Using Mixed Mode Transmission”; and U.S. patent application Ser. No. 12/639,512 entitled “System And Method For Rendering Advertisements On An Electronic Device.” The disclosures of each of these patent applications is incorporated, by reference, in its entirety.

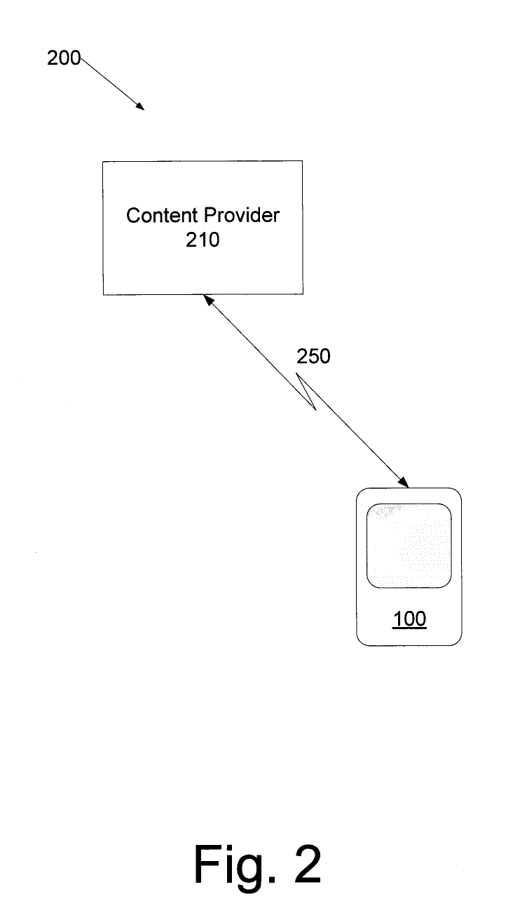

Referring to FIG. 2, a system for providing automatic continuation marks in an electronic publication on an electronic device is provided. System 200 includes electronic device 100 and content provider 210. Other participants may be included as necessary and/or desired.

In one embodiment, content provider 210 may provide content that is rendered on an electronic reading device. Examples of content provider 210 include newspaper publishers, periodical publishers, book publishers, Internet authors, schools, government agencies, etc.

In one embodiment, content provider 210 may be the author of the content. In another embodiment, content provider 210 may be a distributor of content.

Electronic device 100 may communicate with content provider by communication link 250. Communication link 250 may be any suitable wired or wireless communication method, including cellular communications, a USB interface, unshielded twisted pair interface, radio frequency (RF), infrared (IR), Bluetooth, near field communication, WiFi (e.g., any suitable IEEE 802.11 protocol), etc.

The continuation mark may be implemented in several ways. In one embodiment, the continuation mark may be implemented by content provider 210. In another embodiment, the continuation mark may be implemented by electronic device 200. In yet another embodiment, the implementation of the content mark may be spread among multiple sources and/or components. For example, in one embodiment, a content layout engine, which may be provided at a server of content provider 210, may calculate the placement of the continuation marks. This may be performed at the time of content layout compilation. The rendering of continuation marks, as well as the following of the continuation mark links, may be performed by the software and applications on electronic device 200.

Other techniques and methods for implementing the continuation mark may be used as necessary and/or desired.

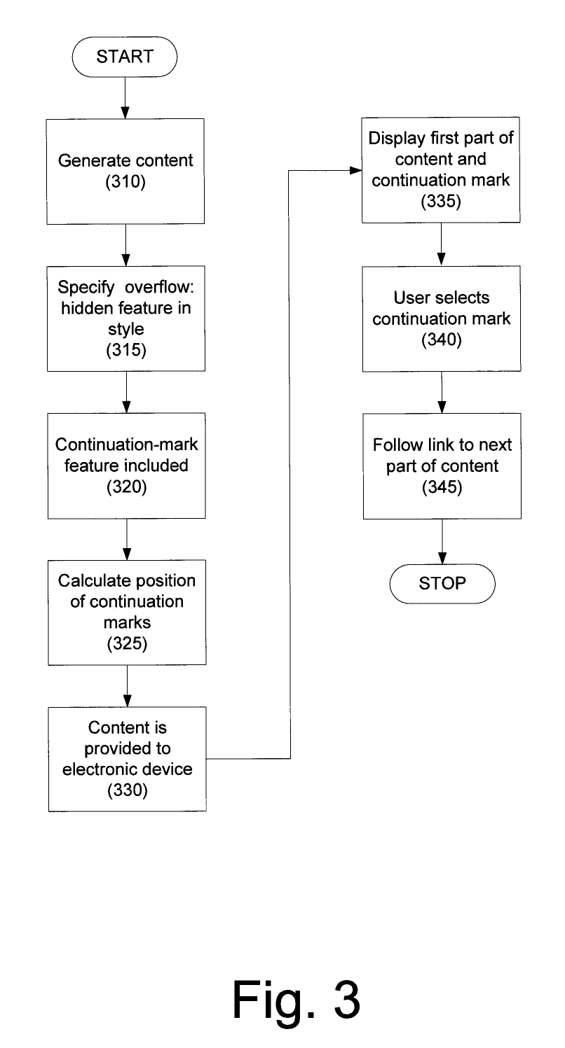

Referring to FIG. 3, a method for providing automatic continuation marks in an electronic publication on an electronic device is provided. In step 310, the content is generated by a content author, content editor, etc. In step 315, the style for the content is defined to include the “overflow: hidden” feature. In step 320, the continuation-mark feature may be included. In one embodiment, the continuation-mark feature may be a child element of the parent in which it is to appear.

In step 325, the positions of the continuation mark, or marks, may be calculated. Links specified by, for example, the content creator may also be generated. For example, in one embodiment, the link may be a hyperlink to the full content. In another embodiment, the link may be to overflow content. In one embodiment, this may be performed when the content is being finalized or laid out.

In one embodiment, the link to overflow content may be generated automatically. In another embodiment, the link may reveal the overflow content in-place.

In one embodiment, this may be performed by servers executing content creating tools. When a content creation tools process XHTML and CSS, the tools generate CSS boxes from the XHTML elements as specified by the CSS. This may include the values of the “display” properties of all of the elements. Once the display boxes are created, they are laid out according to the rules of the CSS box model. Elements with the “display:continuation-mark” property may be turned into “continuation-mark” boxes. These boxes may then be automatically positioned inside their parent in order to appear in the correct place for a continuation-mark.

In one embodiment, the content tools may only position and display a continuation-mark box if its parent has overflow content.

In another embodiment, an application running on the electronic device may calculate and generate the links as necessary and/or desired.

In step 330, the content may be provided to the electronic device. Any suitable delivery mechanism may be used, including RF, cellular, WiFi, USB, memory, etc.

In step 335, the content and continuation mark at the appropriate location are rendered. In one embodiment, the electronic device does not need to interpret the “overflow:hidden” or “display:continuation-mark” properties, and instead renders the formatted content.

In step 340, the user of the electronic device selects the continuation mark.

In step 345, the electronic device follows the link to the next part of the content, and renders that content, along with any additional continuation marks.

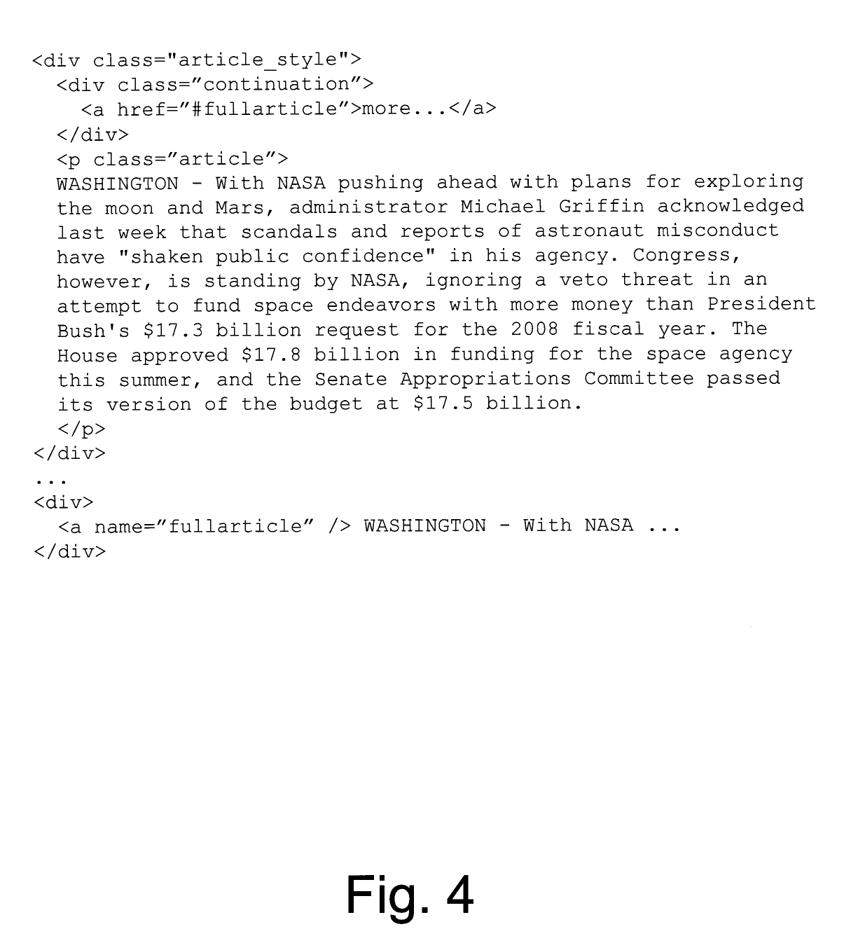

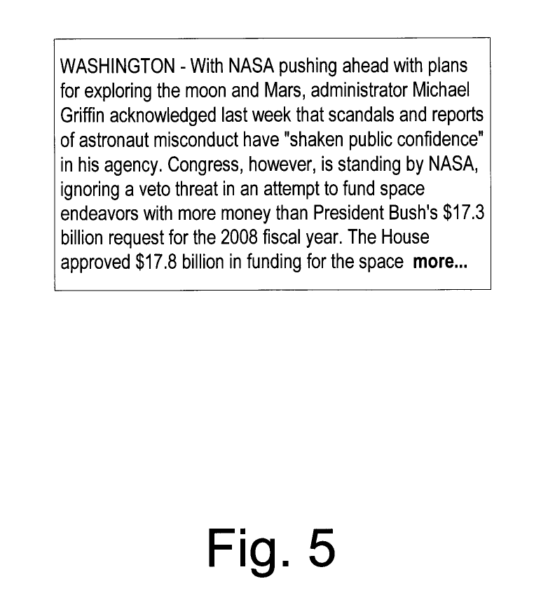

Referring to FIG. 4, an example markup using the continuation mark is provided, while FIG. 5 illustrates the content rendered in a text box. As shown in FIG. 5, the first part of the text flows into the fixed sized box (in this example, with “article_style” styling), but is truncated at the required end of the fixed size box depending upon zoom-state (e.g., the font size in which the text is rendered). Additional space at the end of the fixed size box may be reserved for the continue mark (in this example, with “continuation” styling).

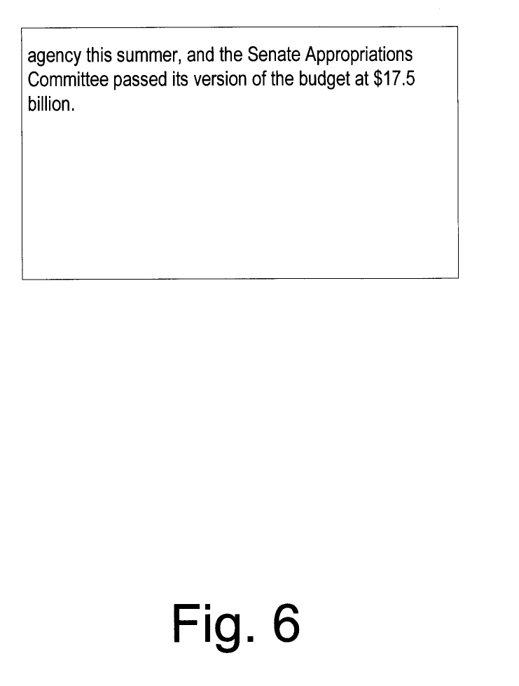

FIG. 6 illustrates the result of a user selecting the “more . . . ” continuation mark. The link associated with the continuation mark is followed and the remainder of the article is rendered.

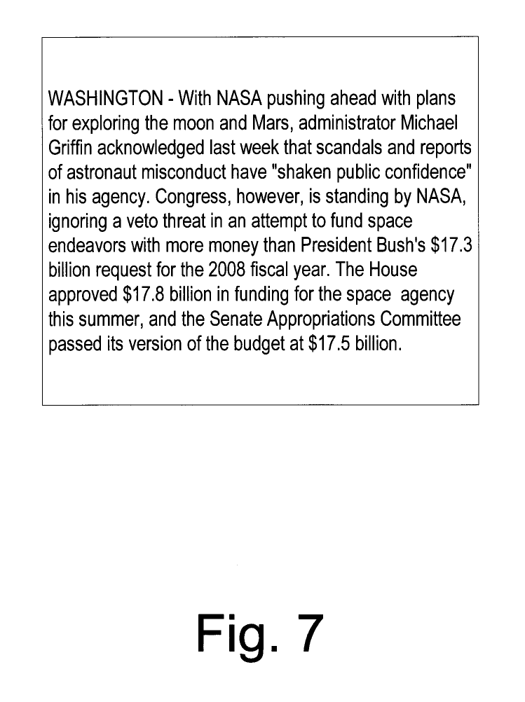

In another embodiment, if the user selects the “more . . . ” continuation mark, the entire content may be rendered. An example is shown in FIG. 7.

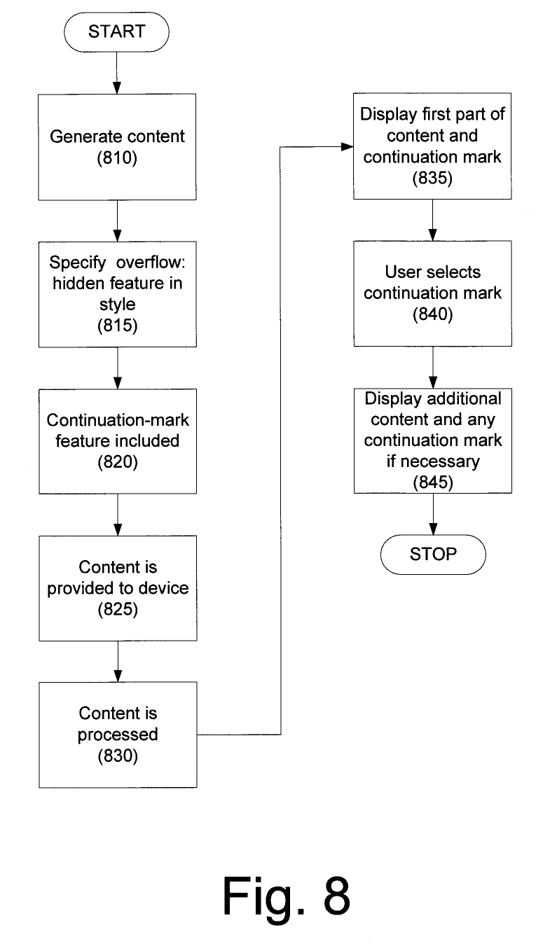

Referring to FIG. 8, a method for providing automatic continuation marks in an electronic publication on an electronic device is provided. In step 810, the content is generated by a content author, content editor, etc. In step 815, the style for the content is defined to include the “overflow: hidden” feature. In step 820, the continuation-mark feature may be included. In one embodiment, the continuation-mark feature may be a child element of the parent in which it is to appear.

In step 825, the content is provided to an electronic device. Any suitable means for providing the content may be used.

In step 830, the electronic device may process the “overflow: hidden” feature and the “display:continuation-mark” feature to the received content. Thus, the electronic device may identify the content that does not fit within the text box and calculate the positions of the continuation marks.

In step 835, the first content and continuation mark at the appropriate location are rendered.

In step 840, the user of the electronic device selects the continuation mark.

In step 845, the second part of the content is displayed along with any additional continuation marks.

In one embodiment, the location of the continuation mark may be recalculated in response to user actions. For example, in one embodiment, if the user changes the zoom state, a larger or smaller amount of content may be displayed in the text box, thereby either eliminating the need for the continuation mark, or requiring a new location.

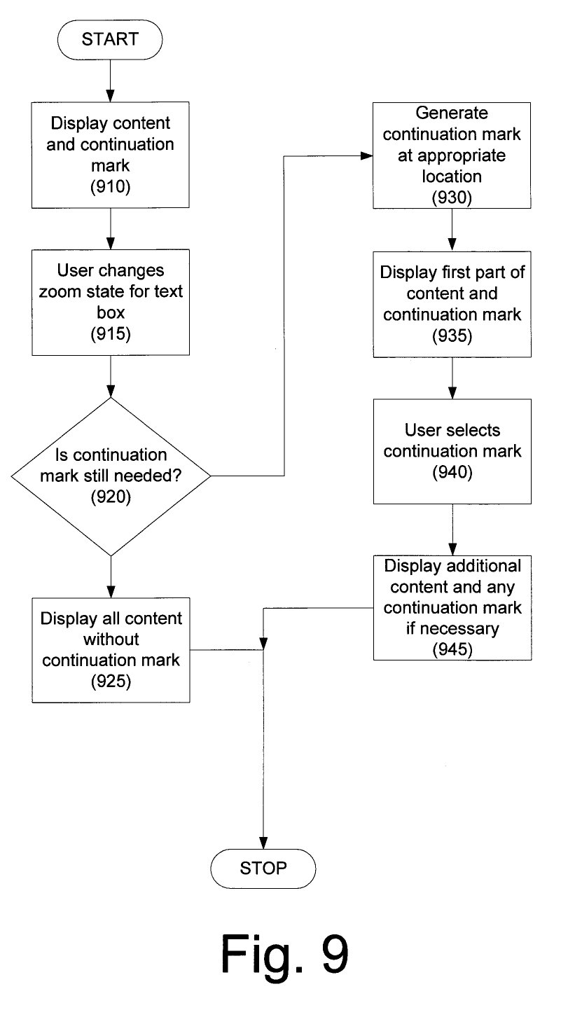

Referring to FIG. 9, a method of modifying the location of a continuation mark is provided. In step 910, content, including a continuation mark, is rendered for the user. In step 915, the user changes the zoom state for the content within the text box.

In step 920, a determination is made, based on the new zoom state, whether a continuation mark is necessary. If the content all fits within the text box, in step 925, then the content is displayed without a continuation mark.

In step 930, the content is processed to calculate the location of a continuation mark. This step is similar to step 830, described above.

In step 935, the content and continuation mark at the appropriate location are rendered. This step is similar to step 835, described above.

In step 940, the user of the electronic device selects the continuation mark. This step is similar to step 840, described above.

In step 945, the hidden content is displayed along with any additional continuation marks. This step is similar to step 845, described above.

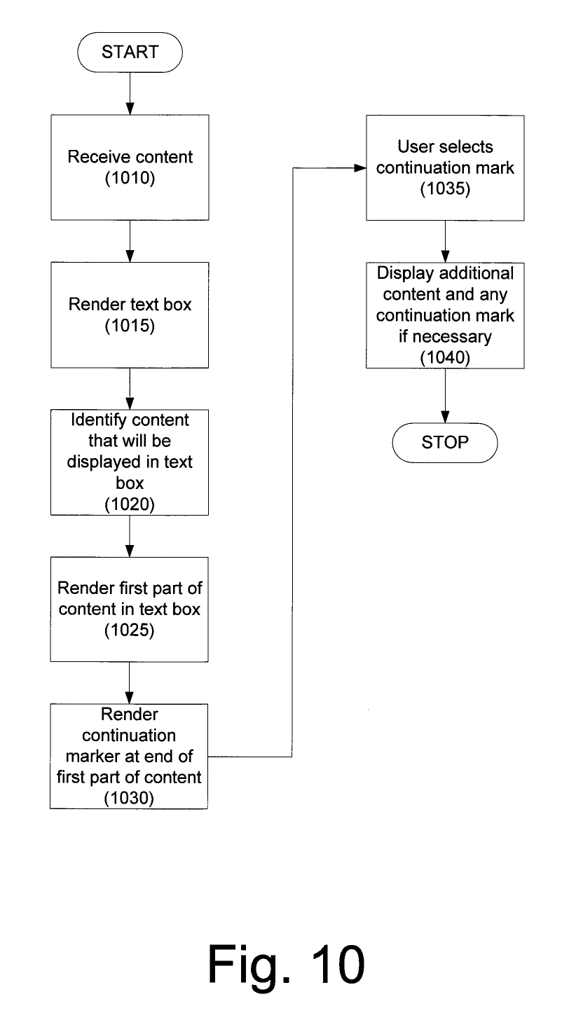

Referring to FIG. 10, a method of rendering content with continuation marks using an electronic device is provided. In step 1010, electronic content is received by the electronic device. In one embodiment, the electronic content may be provided by a content author, content editor, publisher, on-line vendor, etc.

In one embodiment, the electronic content may include a content overflow style, such as the “overflow: hidden” feature.

In step 1015, a text box is rendered on the screen of the electronic device. In one embodiment, the text box may be the dimensions on the screen. In another embodiment, the text box may be smaller than the dimensions of the screen. In still another embodiment, a least one of the dimensions of the text box may be adjusted by the user.

The text box may be displayed with or without borders.

In step 1020, the electronic content that can be rendered within a text box displayed on the electronic device is identified. In one embodiment, this may be in response to the inclusion of the “overflow: hidden” feature.

In step 1025, the first part of the electronic content is to be rendered in the text box.

In step 1030, a continuation mark is generated and rendered in the text box. In one embodiment, the continuation mark may be rendered at the end of the first content.

In step 1035, the user of the electronic device selects the continuation mark.

In step 1040, the second part of the electronic content is displayed. In one embodiment, if the second part of the electronic content cannot be fully rendered in the text box, the second content that can be rendered within the text box is determined, and that electronic content may be rendered with a text box with a continuation mark.

The process may be repeated until all of the electronic content is rendered, or until the user stops selecting the continuation marks.

A method for automatically providing electronic content with continuation marks is disclosed. According to one embodiment, the method may include using a computer processor, identifying a first part of electronic content that can be rendered in an text box on a display of an electronic device; using the computer processor, calculating a position for a continuation marker to be displayed in the electronic content; using the computer processor, linking the continuation mark to a second part of the electronic content; and using the computer processor, automatically inserting the continuation mark in the electronic content following the first part of the electronic content.

The method may further include receiving an indication to display the second part of the electronic content; and displaying the second part of the electronic content.

In one embodiment, identifying a first part of electronic content that can be rendered in an text box may include applying an overflow property to the electronic content.

In one embodiment, the first part of the electronic content may be an abstract of the electronic content.

In one embodiment, the position of the continuation marker may depend on a zoom state of the electronic content.

In one embodiment, the position of the continuation mark may be calculated based on a size of the text box.

In one embodiment, the second part of the electronic content may be the whole electronic content, or it may be less than the whole electronic content.

A method for rendering electronic content with an electronic device is disclosed. According to one embodiment, the method may include receiving an electronic content flow, the electronic content flow comprising text and automatic continuation marks; rendering a first part of the electronic content flow in a text box on an electronic device; rendering a continuation mark at the end of the first part of the electronic content flow, the continuation mark linking to a second part of the electronic content flow; receiving an indication to render the second part of the electronic content flow; and rendering the second part of the electronic content.

In one embodiment, the first part of the electronic content may be an abstract of the electronic content.

In one embodiment, the second part of the electronic content may be the whole electronic content, or it may be less than the whole electronic content.

An electronic device that renders a electronic content is disclosed. According to one embodiment, the electronic device may include a processor; a user interface; a display; and a memory comprising code that when executed by the processor performs the following: identify a first part of electronic content that can be rendered in a text box rendered on an electronic device; render a first part of the electronic content in the text box; render a continuation mark in the text box at the end of the first part of the electronic content; and hide a second part of the electronic content.

In one embodiment, the code may also display the second part of the electronic content in response to an indication to display the second part of the electronic content.

In one embodiment, the first part of the electronic content may be an abstract of the electronic content.

In one embodiment, the position of the continuation marker may depend on a zoom state of the electronic content.

In one embodiment, the position of the continuation mark may be calculated based on a size of the text box.

In one embodiment, the second part of the electronic content may be the whole electronic content, or it may be less than the whole electronic content.

In one embodiment, the electronic device may be an electronic reading device.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

The processing machine used to implement the invention may utilize a suitable operating system. Thus, embodiments of the invention may include a processing machine running the Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, light pen, keyboard, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method for automatically providing electronic content with continuation marks, comprising:
using a computer processor, identifying a first part of electronic content that can be rendered in an text box on a display of an electronic device;
using the computer processor, calculating a position for a continuation marker to be displayed in the electronic content;
using the computer processor, linking the continuation mark to a second part of the electronic content; and
using the computer processor, automatically inserting the continuation mark in the electronic content following the first part of the electronic content.

2. The method of claim 1, wherein the step of identifying a first part of electronic content that can be rendered in an text box comprises applying an overflow property to the electronic content.

3. The method of claim 1, wherein the first part of the electronic content is an abstract of the electronic content.

4. The method of claim 1, wherein the position of the continuation marker depends on a zoom state of the electronic content.

5. The method of claim 1, wherein the position of the continuation mark is calculated based on a size of the text box.

6. The method of claim 1, further comprising:
receiving an indication to display the second part of the electronic content; and
displaying the second part of the electronic content.

7. The method of claim 1, wherein the second part of the electronic content is the whole electronic content.

8. The method of claim 1, wherein the second part of the electronic content is less than the whole electronic content.

9. A method for rendering electronic content with an electronic device, comprising:
receiving an electronic content flow, the electronic content flow comprising text and automatic continuation marks;
rendering a first part of the electronic content flow in a text box on an electronic device;
rendering a continuation mark at the end of the first part of the electronic content flow, the continuation mark linking to a second part of the electronic content flow;
receiving an indication to render the second part of the electronic content flow; and
rendering the second part of the electronic content.

10. The method of claim 9, wherein the first part of the electronic content is an abstract of the electronic content.

11. The method of claim 9, wherein the second part of the electronic content is the whole electronic content.

12. The method of claim 9, wherein the second part of the electronic content is less than the whole electronic content.

13. An electronic device that renders a electronic content, comprising:
a processor;
a user interface;
a display; and
a memory comprising code that when executed by the processor performs the following:
identify a first part of electronic content that can be rendered in a text box rendered on an electronic device;
render a first part of the electronic content in the text box;
render a continuation mark in the text box at the end of the first part of the electronic content; and
hide a second part of the electronic content.

14. The system of claim 13, wherein the first part of the electronic content is an abstract of the electronic content.

15. The system of claim 13, wherein the position of the continuation marker depends on a zoom state of the electronic content.

16. The system of claim 13, wherein the position of the continuation mark is calculated based on a size of the text box.

17. The system of claim 13, wherein the code further displays the second part of the electronic content in response to an indication to display the second part of the electronic content.

18. The system of claim 13, wherein the second part of the electronic content is the whole electronic content.

19. The system of claim 13, wherein the second part of the electronic content is less than the whole electronic content.

20. The system of claim 13, wherein the electronic device is an electronic reading device.
